(19) United States
(12) Patent Application Publication
(10) Pub. No.: US 2008/0134813 A1
(43) Pub. Date: Jun. 12, 2008

(54) Mechanism for Converting a Rectilinear Movement Into an Arcuate Movement Usable in a Scanning Device

(76) Inventor: Arnaud Petetin, Saint Georges de Mons (FR)

Correspondence Address: BROWDY AND NEIMARK, P.L.L.C.;624 NINTH STREET, NW, SUITE 300, WASHINGTON, DC, 20001-5303, US

(21) Appl. No.: 11/547,481

(22) PCT Filed: Mar. 17, 2005
(86) PCT No.: PCT/FR05/00676

§ 371 Date: Aug. 15, 2007

(30) Foreign Application Priority Data
Apr. 1, 2004 (FR) 0403524

(51) Int. Cl. F16H 37/10; G10K 11/35

(52) U.S. Cl. 74/37; 74/52; 74/25

(57) ABSTRACT

The invention relates to a mechanism for converting a linear motion into an arcuate motion, which can be used in a scanning device. The inventive mechanism comprises: a structure (35) which can move along a linear path and which can be connected to a drive device (34), a support part (39) which is mounted to the mobile structure (35) such that it can slide perpendicularly to the aforementioned linear path, at least one connecting rod (48, 49) which is articulated to (i) a fixed structure around a first axis of rotation located in a plane that is perpendicular to the linear path and (ii) the mobile structure (35) around a second axis that is parallel to the first. The arcuate movement of the support part (39) results from the sliding thereof under the action of the connecting rod (48, 49′) and the translational movement produced by the mobile structure (35′).

This invention relates to a conversion mechanism that can be used to drive an object, for example a transducer, along an arcuate path with a fixed or variable curvature, from a rectilinear movement.

It applies in particular, but not exclusively, to the driving of the transducer element of an ultrasound probe.

It is known that in numerous fields of application, it is necessary to use ultrasound probes of decreasing sizes, which probes must necessarily use a transducer mounted on a more or less complex mechanism driven most often by an electrical motor reduction unit. Usually, they have a tubular body with a cylindrical shape, which the diameter corresponds substantially to the diameter of the motor reduction. The driving mechanism of the transducer must then enter a cylindrical volume of which the diameter is as close as possible, or even smaller than that of the motor. Due to the miniaturisation of motors and the requirements imposed by the mode of application of the probe, the volume dedicated to these mechanisms decreases progressively. However, these mechanisms often have relatively complex kinematics. Their production then becomes less simple, and even problematic.

In addition, the level of precision required by these mechanisms as well as by the sensors associated with them for control purposes is normally very high. In this case as well, the reduction in the available volume tends to increase the difficulty of achieving such levels of precision.

Thus, for example, these mechanisms generally involve kinematics making it possible to convert the rotation movement of the motor into an alternative rectilinear movement that can be used to drive the transducer element. For this type of application, the invention relates more specifically to a mechanism making it possible to convert this rectilinear movement into an arcuate movement of the transducer element.

Nevertheless, more generally, the mechanism according to the invention involves:
a structure that is mobile with respect to a stationary structure along a linear path, this mobile structure being capable of being coupled to a drive device,
a support part slidably mounted on said mobile structure perpendicularly to said path,
at least one connecting rod connected to the stationary structure so as to pivot about a first rotation axis located in a plane perpendicular to said path and connected to the mobile structure so as to pivot about a second axis parallel to the first.

Owing to these provisions, the arcuate movement of a point of said support part results from the product of its sliding movement under the action of the connecting rod and the translation caused by the mobile structure.

If the mechanism is used to perform an arcuate-type scanning of an ultrasound probe, the transducer element is mounted on said support part so as to rotate about a third axis parallel to the first two axes.

In this case, it also comprises means for driving the transducer element in rotation according to the angular position of said connecting rod.

These drive means can advantageously involve at least:
a first pulley or pinion securely connected to the rod and mounted coaxially with respect to said second axis,
a second pulley or pinion securely connected to the transducer element and mounted coaxially with respect to said third axis,
drive means such as, for example, a belt or a chain coupling said pulleys or pinions.

The invention is not limited to a particular type of device for driving the mobile structure along a linear path.

Thus, for example, this drive device can involve a circular movement (of a motor)/linear movement conversion mechanism.

In this case, this mechanism can be of the connecting rod/crank-type or even of the sun-gear/planet gear-type.

In this latter case, this mechanism can involve a rotating planetary plate driven in rotation by the motor output shaft, a planet pinion pivotably mounted on the plate and meshing with a ring gear with a toothed bore coaxial to said shaft and securely connected to the body of the motor, and an axial drive member borne by a support securely connected to the pinion, the diameter of the pinion being equal to half the diameter of the bore of the column and the drive member being arranged so that, when the plate rotates, said member follows a rectilinear path connecting two diametrally opposed points of the ring gear.

Of course, the drive member of this mechanism can be coupled to said mobile structure of the rectilinear movement/arcuate movement conversion mechanism by a rigid connection, by a hinged connection or by a remote coupling (for example a magnetic coupling).

Owing to these provisions, we obtain a drive mechanism occupying a planar cylindrical volume coaxial to the motor and substantially of the same diameter. The sinusoidal movement of the drive member is obtained with minimal friction, with low wear and very small clearance.

It is noted that this mechanism is perfectly suitable for a servo-control system.

Embodiments of the invention will be described below, by way of non-limiting examples, in reference to the appended drawings in which:

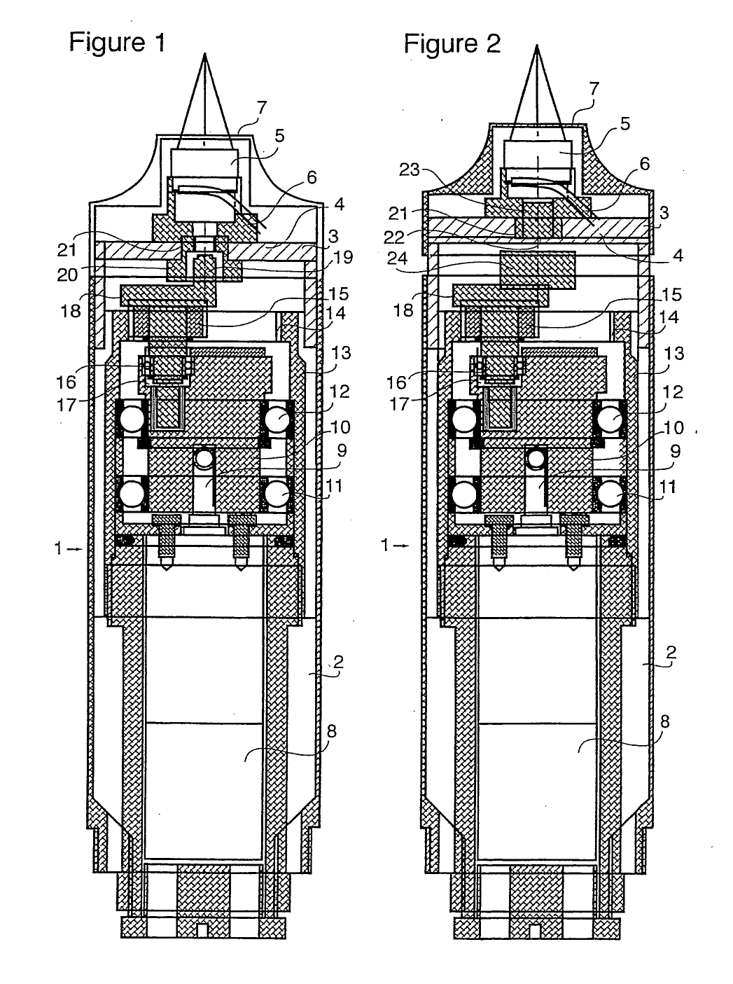

FIGS. 1 and 2 are axial cross-sections of two alternative embodiments of an ultrasound probe with linear movement;

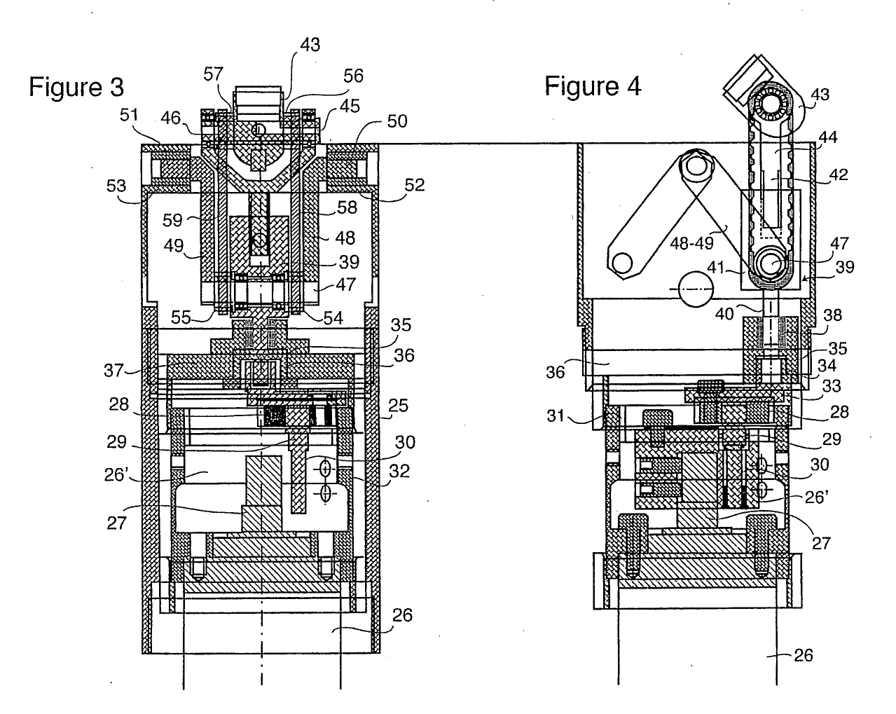

FIGS. 3 and 4 are axial cross-sections 90° from one another of an ultrasound probe with arcuate movement.

In the examples shown in FIGS. 1 and 2, the probe comprises a tubular body 1 divided into two compartments 2, 3 by a transverse partition 4. The front compartment 3 houses a transducer element 5 mounted on a support part 6 that is mobile in translation on the partition 4. This transducer 5 is designed so as to emit focused ultrasound radiation through the front wall 7 of the probe.

In the example shown in FIG. 2, this front compartment 3 is sealed and can be filled with a liquid making it possible to ensure good transmission of the ultrasound waves.

The rear compartment 2 contains a motor reduction unit as well as a mechanism for conversion of the rotational movement of the output shaft 9 of this motor 8 into an alternative rectilinear movement.

This mechanism involves a cylindrical drive part 10 rotatably mounted coaxially to the output shaft 9 of the motor 8 by means of two axially offset bearings (or ball bearings) 11, 12 borne by a tubular shaft sleeve 13 secured to the body of the motor 8.

This tubular shaft sleeve 13 comprises, at its front end, internal gear teeth (toothed ring gear 14) with which a planet pinion 15 meshes, which planet pinion is pivotably mounted on the drive part 10 owing to a shaft 16 that is engaged in a cylindrical bore 17 of the drive part 10, arranged so that it is parallel to the spindle 9 of the motor 8 at a predetermined distance therefrom. The rotational assembly of the shaft 16 in the bore 17 is ensured by means of a bearing (or a ball bearing) provided between said shaft 16 and the wall of said bore 17.

The pinion 15 has on its upper surface a support part 18 of a drive member of the support part 6 of the transducer element 5.

In the example shown in FIG. 1, the drive member consists of an axial pin 19 is engaged in the cavity of a slide 20 that is mobile along a slot 21 provided in the partition 4 and that is attached to the support part 6.

Thus, when the motor 8 rotates, the pinion 15 borne by the drive part 18 turns along a coaxial circular path. Along this path, it meshes with the gear teeth 14 of the tubular shaft sleeve 13 by rotating about an axis parallel to the shaft 9 of the motor 8.

The movement of the pin 19, which corresponds to the product of the double rotation (planet/sun) is an alternative rectilinear movement. The partition 4 is arranged so that the path of the pin follows the path of the slot 21 and, thus, the transducer element itself performs an alternative rectilinear movement.

Advantageously, the cavity of the slide 20 intended to receive the pin 19 will be oblong, so as to tolerate alignment differences.

In the example shown in FIG. 2, the partition 4 comprises, instead of a slot, a groove 21 closed off by a base 22. The support part 6 has a T-shape of which the vertical branch is engaged and guided in the groove 21.

This vertical branch, of which the width corresponds to that of the groove 21, comprises a central cavity housing a first permanent magnet 23.

The drive member in this case consists of a second permanent magnet 24 with a polarity opposite that of the first, attached to the upper surface of the support part 18. This magnet 24 is therefore mobile along a rectilinear path parallel to and near the partition 4.

We thus obtain a magnetic coupling of the two permanent magnets 23, 24 and a contactless drive movement of magnet 23 by magnet 24 along the groove 21.

Of course, the invention is not limited to a particular form of movement.

Thus, the mechanism according to the invention can be used to produce rectilinear movement/arcuate movement conversion kinematics.

FIGS. 3 and 4 show an embodiment of such an application.

These figures show an ocular ultrasound probe with arcuate movement using a drive mechanism with rectilinear movement similar to that used in the probe shown in FIGS. 1 and 2.

It is noted that this type of probe has the particular feature of taking into account the fact that the cornea is not really spherical, but has significant variations between its centre and the periphery. In fact, the base plane of the cornea has an elliptical shape with a large diameter D on the order of 12 mm and a small diameter on the order of 11 mm, with the difference in diameter resulting from the opening and closing of the eyelids.

In addition, it is recognized that the cornea has two zones, a central zone that is spherical and a peripheral zone in which the radius of curvature increases progressively toward the limbus. It therefore appears that the cornea is an aspherical and asymmetrical cap, which flattens progressively toward the periphery. Due to the different radii of curvature between the cornea and the sclera, the junction of the cornea and the sclera has a sulcus that is apparent at the level of the iridocorneal angle.

The advantage of the arcuate scanning is that it allows the probe to follow a path of which the radius of curvature is fixed and substantially equal to the mean radius of curvature of the cornea, while maintaining the axis of the ultrasound beam orthogonal to a large portion of the surface of the cornea and/or the retina, with a view to improving the quality of the ultrasound signal received by the probe, while preventing it from coming close to the sclera and the risk of hitting it.

The probe shown in FIGS. 3 and 4 is therefore designed to achieve these results, by means of a mechanism making it possible to considerably reduce the size of the probe while preserving high levels of precision and performance.

This probe comprises a tubular support structure 25 containing, in its lower portion, a motor 26 of which the output shaft 27 drives a cylindrical part 26′ on which a pinion 28 is rotatably mounted owing to a pin 29 that is engaged in a guide track consisting of a bearing and ball bearings mounted in a bore 30 formed in the front surface of the cylindrical part, parallel to the axis of the shaft 27, and at a predetermined distance therefrom.

This pinion 28 meshes with the gear teeth of a toothed ring gear 31 borne by a tubular shaft sleeve 32 securely connected to the body of the motor 26. In this case, it supports a drive part 33 equipped with an axial drive finger 34 that, when the motor 26 rotates, performs a rectilinear movement along a diameter of the tubular shaft sleeve 32.

This finger 34 is engaged in the rear element of a tubular slide 35 passing through a slot 36 formed in a transverse partition 37 securely connected to the tubular shaft sleeve 32.

This slide 35 is produced by assembling two shouldered front/rear tubular elements, of which the shoulders rest on the partition 37. This slide can therefore move along the slot 36 while being held axially in both directions by the shoulders.

The finger 34 comprises a coaxial bore that extends in the extension of a bore 38 of the front element of the slide 35 so as to form a cylindrical bearing therewith.

A cylindrical support part 39 is axially slidably mounted in this bearing, which support part has a lower portion 40 that is engaged in the cylindrical bearing and an upper portion 41 with a larger diameter that serves as a support for an arm 42 bearing the transducer element 43 of the probe and a hinge for a connecting rod assembly.

More specifically, the upper portion of the part 39 comprises a coaxial bore in which a rod is attached by a spline, which rod has a front end in the shape of a fork that constitutes a hinge lug 44. This lug 44 comprises two transverse coaxial bores in which, on ball bearings, two coaxial pivot pins 45, 46, securely connected to the transducer element 43, are mounted.

In addition, the part 39 comprises a transverse bore in which a transverse pin 47 is pivotably mounted on ball bearings, which pin has two ends going beyond the part that are respectively securely connected to the ends of two parallel longitudinal connecting rods 48, 49 constituting said connecting rod assembly.

The ends of these two connecting rods 48, 49, opposite the axis 47, are equipped with two respective coaxial pivot pins 50, 51 arranged so as to be parallel to the pin 47, which are engaged and pivotably mounted in two respective bearings located in an axial plane perpendicular to the slot. These bearings are arranged in housings 52, 53 provided in the tubular structure 25, near the front opening thereof.

The ends of the pin 47 extending from the part 39 comprise two respective toothed pulleys 54, 55 located opposite two corresponding pulleys 56, 57 provided on the pivot pins 45, 46 of the transducer element 43.

The pairs of pulleys opposite one another are connected by two respective toothed belts 58, 59.

Owing to these provisions, when the motor 26 is actuated, the finger 34 performs and alternative linear movement along the groove 36 in the manner indicated in FIG. 1.

During this movement, it causes a translation movement of the slide 35 and a tilting of the two connecting rods 48, 49 about the axis of the pivot pins 50, 51. The part 39 driven in translation by the slide under the effect of the circular movement of the pin 47 performs an axial movement by sliding into the bearing of the bore 38.

As a consequence, the axis of the pivot pins 45, 46 describes an arcuate path that is the product of the translation movement caused by the slide 35 and the axial movement caused by the connecting rods 48, 49.

During this movement, owing to the action of the toothed belts 58, 59, the orientation of the transducer element 43 varies according to the orientation of the connecting rods 48, 49 and therefore according to the position of the slide 35, the nature of this variation being dependent on the ratio of the diameters of the toothed pulleys 54-55 and 56-57.

It clearly appears upon examination of FIGS. 3 and 4 that an important advantage of the solution described above results from its compactness and its capacity for miniaturization.

Of course, the invention is not limited to the embodiment described above. Thus, for example, if in a particular embodiment the transducer is attached to the rotation pin 50-51, the movement obtained will be of a sector-type in which the angle will be a function of the length of the connecting rods 48-49.

1. Mechanism for converting a rectilinear movement into an arcuate movement that can be used in a scanning device, comprising:
a structure that is mobile with respect to a stationary structure along a linear path, this mobile structure being capable of being coupled to a drive device,
a support part slidably mounted on said mobile structure perpendicularly to said path, at least one connecting rod connected to the stationary structure so as to pivot about a first rotation axis located in a plane perpendicular to said path and connected to the mobile structure so as to pivot about a second axis parallel to the first,
wherein said support part is subjected to an arcuate movement resulting from the product of its sliding movement under the action of the connecting rod and the translation caused by the mobile structure.

2. Mechanism according to claim 1, wherein, if it is used for arcuate scanning of an ultrasound probe, the transducer element is mounted on said support part so as to rotate about a third axis parallel to the first two, with drive means also being provided in order to drive the transducer element in rotation depending on the angular position of said connecting rod.

3. Mechanism according to claim 2, wherein said drive means involve at least:
one first pulley or pinion securely connected to the connecting rod and mounted coaxially with respect to said second axis,
a second pulley or pinion securely connected to the transducer element and mounted coaxially with respect to said third axis,
drive means such as, for example, a belt or a chain coupling said pulleys.

4. Mechanism according to claim 1 comprising:
two parallel connecting rods mounted by one of their ends on a structure securely connected to the body of the motor in two diametrally opposed positions, and by their other ends on said support part so as to pivot about a common transverse pin,
two primary pulleys or pinions respectively securely connected to said connecting rods and mounted coaxially with respect to said common transverse pin,
two secondary pulleys or pinions securely connected to said transducer element and mounted coaxially with respect to the pivot axis of the transducer element, said two secondary pulleys or pinions constituting, with the primary pulleys or pinions two pairs of pulleys or pinions opposite one another and two drive chains or belts respectively passing around the two pairs of pulleys or pinions opposite one another.

5. Mechanism according to claim 1 wherein said device for driving the mobile structure comprises a mechanism for converting the circular movement of a motor member into a linear movement.

6. Mechanism according to claim 5, wherein said conversion mechanism is of the sun/planet gear-type and comprises a rotating planetary plate driven in rotation by the output shaft of the motor member, a planet pinion pivotably mounted on the plate and meshing with a ring gear with a toothed bore coaxial to said shaft and securely connected to the motor member and a drive member borne by a support securely connected to the pinion.

7. Mechanism according to claim 6, wherein the diameter of the pinion is equal to half the diameter of the toothed bore, and the drive member is arranged so that, when the plate rotates, said member follows a rectilinear path connecting two diametrally opposed points of the ring gear.

8. Mechanism according to claim 5, wherein the drive member is coupled to a support part of the transducer guided along a linear path.

9. Mechanism according to claim 8, wherein the coupling between the support part and the drive member occurs in direct drive by coupling means such as a drive finger or in a contactless manner by coupling means such as magnetic means.

10. Mechanism according to claim 6 comprising the rotating planetary plate consists of a cylindrical drive part rotatably coaxially mounted with respect tot he output shaft of the motor by means of at least one bearing borne by a tubular shaft sleeve securely connected to the body of the motor, which tubular shaft sleeve comprises internal gear teeth constituting said toothed ring gear.

11. Mechanism according to claim 8 comprising magnetic coupling means, and in that the support part of the transducer element and said conversion device are arranged in two compartments separated by a partition through which the coupling takes place.
